(19) United States
(12) Patent Application Publication
(10) Pub. No.: US 2009/0017749 A1
(43) Pub. Date: Jan. 15, 2009

(54) System and Method for Enhancing Live Events via Coordinated Content Delivery to Mobile Devices

(75) Inventor: Andrew Jonathan Braun, Cary, NC (US)

Correspondence Address: COATS & BENNETT/SONY ERICSSON, 1400 CRESCENT GREEN, SUITE 300, CARY, NC, 27518, US

(73) Assignee: SONY ERICSSON MOBILE COMMUNICATIONS AB, Lund (SE)

(21) Appl. No.: 11/777,495

(22) Filed: Jul. 13, 2007

(51) Int. Cl. H04H 1/00

(52) U.S. Cl. 455/3.01

(57) ABSTRACT

According to teachings presented herein, a system and method enhance live events by providing coordinated content delivery to mobile device subscribers physically present at the live event. As a non-limiting example, a system is configured to feed any one or more of replay video, alternate or zoom camera angles, and supporting information for the event, such as interesting data on event participants, e.g., player statistics, etc. Accordingly, one embodiment of a method of delivering location-based event content to a mobile station comprises determining that the mobile station is physically present at an event venue, identifying desired types of event feeds for the mobile station for a live event at the event venue, and dynamically delivering one or more event feeds of the desired types to the mobile station. A system for supporting the method may be implemented in whole or in part in a cellular communication network.

### BACKGROUND

1. Technical Field

The present invention generally relates to location-based wireless communication services, and particularly relates to providing event feeds to a wireless communication device physically present at a live event.

2. Background

Mobility represents an intrinsic convenience of many types of wireless communication devices, such as cellular telephones and PDAs. Capitalizing on that mobility, it is known to provide certain types of location-based services, such as delivering “static” information to a given mobile device that is particularly relevant to the current location of that device. In this regard, “static” information denotes data that is generally relevant for the mobile device's given locale, such as information on local restaurants and other attractions.

Further, in a limited sense, it is known to deliver some types of dynamic information, such as near real-time traffic information. However, location-based information delivery has heretofore not been configured and employed to enhance the live viewing experience of event attendees.

### SUMMARY

According to teachings presented herein, a system and method enhance live events by providing coordinated content delivery to mobile device subscribers physically present at the live event. As a non-limiting example, a system is configured to feed any one or more of replay video, alternate or zoom camera angles, and supporting information for the event, such as relevant data on event participants, e.g., player statistics, etc.

Accordingly, in one embodiment, a method of delivering location-based event content to a mobile station comprises determining that the mobile station is physically present at an event venue, and identifying desired types of event feeds for the mobile station for a live event at the event venue. The method continues with dynamically delivering one or more event feeds of the desired types to the mobile station. In negotiating feed service and delivering the feeds, the method uses, for example, an appropriately configured cellular communication network having a coverage area that includes the event venue's location, or uses a local wireless network implemented at the event venue, or uses some combination of the two. That is, in at least one embodiment, a combination of local wireless connectivity and wide-area wireless connectivity, e.g., cellular communication service, are used in providing event feeds to the mobile station.

Supporting the above method, and variations of it, one embodiment of a system for delivering location-based event content to a mobile station comprises a detection processor configured to determine that the mobile station is physically present at an event venue, and a service configuration processor configured to identify desired types of event feeds for the mobile station for a live event at the event venue. The system further includes a feed processor configured to dynamically deliver one or more event feeds of the desired types to the mobile station. In one embodiment, these processing elements are implemented in one or more nodes within a cellular communication network, such as in a feed server located in or associated with a core network or an IP Multimedia Subsystem (IMS). In any case, the feed processor is operatively associated with, by wired or wireless links, with one or more communication circuits configured to deliver the event feeds to the mobile station.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a system for dynamically delivering event feeds to a mobile station.

FIG. 2 is a logic flow diagram of one embodiment of processing logic for dynamically delivering event feeds to a mobile station.

FIG. 3 is a block diagram of another embodiment of a system for delivering event feeds to a mobile station.

FIG. 4 is a block diagram of another embodiment of a system for delivering event feeds to a mobile station.

FIG. 5 is a block diagram of another embodiment of a system for delivering event feeds to a mobile station.

### DETAILED DESCRIPTION

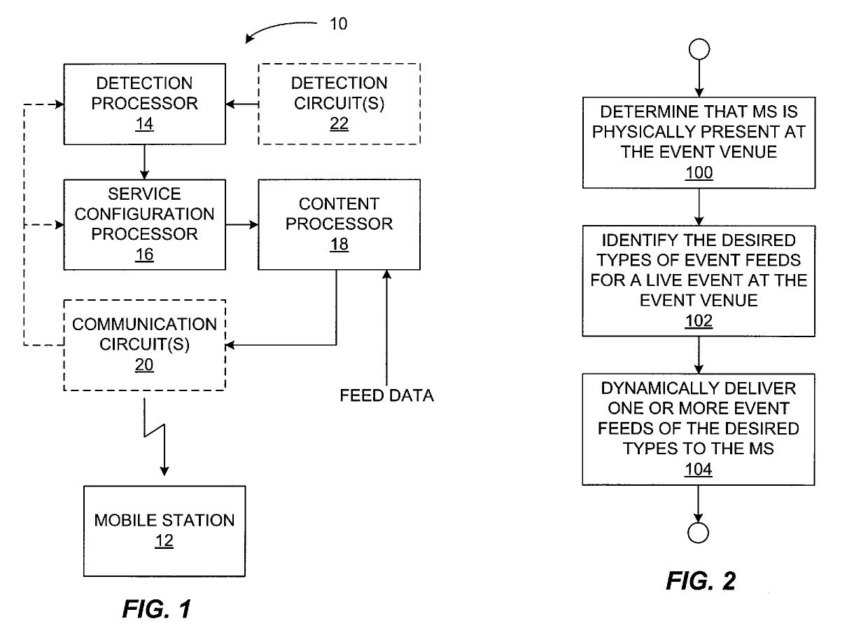

As a non-limiting example, FIG. 1 illustrates a system 10 for delivering location-based event content to a mobile station 12. In the illustrated embodiment, the system 10 comprises a detection processor 14 configured to determine that the mobile station is physically present at an event venue (not shown), a service configuration processor 16 configured to identify desired types of event feeds for the mobile station 12 for a live event at the event venue, and a content processor 18 configured to dynamically deliver one or more event feeds of the desired types to the mobile station 12.

To that end, the content processor 18 is operatively associated with one or more communication circuits 20, which are configured to deliver the event feed(s) to the mobile station 12 via wireless signaling. As will be detailed later, the communication circuits 20 may comprise base stations or other cellular network transceivers, and/or may comprise wireless transceivers local to the event venue. The content processor 18 thus may be directly or indirectly communicatively coupled to the communication circuits 20.

Similarly, the detection processor 14 may be operatively associated with the communication circuits 20, such as to receive GPS information, time-of-arrival (triangulation) information, or other location-based signaling from the mobile station 12, or from another network entity (not explicitly shown) that performs location determination for the mobile station 12. In one example, the detection processor 14 has knowledge of an event venue's geographic location, and thus it “detects” that the mobile station 12 is physically present at the event venue by recognizing that the mobile station's currently reported location coincides with the known event venue location.

Additionally, or alternatively, the detection processor 14 is directly or indirectly associated with one or more detection circuits 22. As a non-limiting example, the detection circuits 22 comprise wireless sensors, such as near-field or other short-range RF transceivers implemented at the event venue, which are configured to detect the presence of the mobile station 12. Such equipment also can be used to communicate with the mobile station 12, such as to negotiate the particular event feeds/types desired by the subscriber of the mobile station 12. It is also contemplated herein, in some cases, to use such equipment for delivering one or more of the event feeds, e.g., a WiFi (802.11) network at the event venue may offer high-rate bearer services for delivering video and other high bandwidth feeds. In any case, the detection circuits 22 may directly couple to the detection processor 14, or indirectly couple to the detection processor 14, such as through a cellular communication network (not shown) that is associated with the detection processor 14.

With these example configurations in mind, FIG. 2 provides a non-limiting example of processing that can be implemented by the system 10 for delivering desired types of event feeds to the mobile station 12. It should be understood that the system 10 may be implemented in hardware, software, or any combination thereof. For example, the detection, service configuration, and content processors 14, 16, and 18, respectively, may comprise all or part of one or more nodes in a wireless communication network.

A “feed server” coupled to or otherwise associated with a cellular communication network (not shown) and/or a local wireless communication network (not shown) at the event venue represents one example implementation for carrying out the processing of FIG. 2. In that and other implementations, the processing of FIG. 2 may be carried out by executing stored program instructions held in a memory or other storage device, where those program instructions comprise one or more computer program products. As will be appreciated by those skilled in the art, such computer program products may comprise a stand-alone computer program, such as may be loaded or otherwise provisioned in a network node by a network operator, or such computer program products may comprise part of a larger or more comprehensive computer program product.

Regardless, the illustrated processing begins with determining that the mobile station 12 (abbreviated “MS” in the diagram) is physically present at the event venue (block 100). Again, detection may comprise directly detecting the presence of the mobile station 12, receiving a signal that indicates the presence of the mobile station 12, or receiving location information for the mobile station 12 and using that information to determine that the mobile station 12 is at the event venue.

Processing continues with identifying the desired types of event feeds for a live event at the event venue (block 102). That is, processing continues with determining the types of event feeds that subscriber of the mobile station 12 wishes to receive in conjunction with his or her attendance at the live event. As a non-limiting example, types of event feeds for a sporting event may include various video, audio, and data feeds. Examples of video feeds include instant replay and alternate/zoom camera angle feeds. Examples of audio feeds include sounds from in-game microphones, etc. Examples of data feeds include player, team, and game statistics, as well as biographical and other information (or web links thereto) for information relevant to the players. Examples of feed types for a music event include set list information, band/artist information, song lyrics (which may be coordinated with the actual performance), artist catalogs and links for related music purchases (such as “buy current song”), etc.

Further, with precise location information, i.e., knowing where the mobile station 12 is at within the event venue in particular, one or more of the event feeds can be tailored to that specific location. For example, the precise location may be used to identify “opposite” camera angles for providing video feeds (for replay, zoom, etc.) to the mobile station from the opposite side of the event venue.

In any case, with or without precise location information, preconfigured subscription information may be used to determine the types of event feeds desired. As an example, there may be subscription classes (e.g., “gold,” “silver,” and “bronze”) defined by the network operator or other content provider, which define the range or types of event feeds to be delivered to the mobile station 12 when its presence is detected at a live event (at least for given types of live events and/or at least for given event venues).

Additionally, or alternatively, the desired types of event feeds may be actively negotiated with the subscriber, such as by sending a notification to the mobile station 12 identifying the availability of event feeds, their respective costs, etc. The subscriber thus may pick from a menu of available event feeds, and make or confirm payment arrangements, etc. Such signaling may rely exclusively on a supporting cellular communication network, a local wireless network at the event venue, or a combination of such networks. (Note that it is contemplated herein to implement feed-related processing entities that are shared between cellular and local wireless networks, or that are otherwise accessible between such networks, such as through an interworking function.)

The illustrated processing continues with dynamically delivering one or more feeds of the desired types to the mobile station 12. In other words, the illustrated processing delivers electronic content corresponding to, or otherwise relevant to, the live event being attended by the subscriber of the mobile station 12. In a rich communication environment, i.e., with high-rate communication links available, the event feeds can, as mentioned previously, include real-time or near real-time video, such as instant replays, additional or alternate camera angles, zoomed camera views, broadcast booth/color commentary feeds, etc. Of course, the types of event feeds available for a given live event may change to reflect the nature of the event itself. In general, the event feed service is intended to enhance the attendance experience.

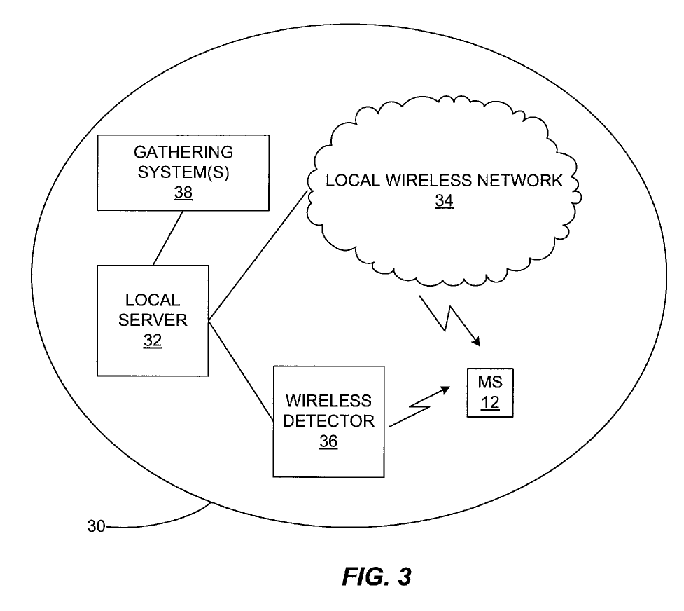

FIG. 3 illustrates one embodiment for providing some or all of the above services, wherein the system 10 (not explicitly enumerated in the figure) is implemented locally at an event venue 30, which may be a stadium or other building or structure. In more detail, the system 10 in this embodiment is implemented as a local server 32 communicatively coupled to a local wireless communication network 34. The local wireless communication network 34 comprises, as a non-limiting example, an IEEE 802.11g/n (WiFi) network offering radio coverage in all or at least a portion of the event venue 30.

In at least one embodiment, the local wireless communication network 34 provides a basis for detecting the physical presence of the mobile station 12 at the event venue 30. For example, discovery and/or handshaking registration protocols associated with the wireless communication network 34 may be used to detect the mobile station's presence and, if desired, to negotiate or otherwise identify the desired types of event feeds. Of course, this assumes that the mobile station 12 includes a communication circuit compatible with the local wireless communication network 34.

In other embodiments, the system 10 includes or is associated with one or more wireless detectors 36, which may be positioned at entry points (i.e., venue gates or passageways), or positioned at the seating or viewing locations. In at least one such embodiment, the wireless detector(s) 36 comprise a plurality of wireless transceivers 36, e.g., near field communication (NFC) transceivers, positioned at each seating location, or at groups of seating locations.

In this manner, the mobile station 12 may at least be detected upon the subscriber taking his or her seat. Advantageously, because the point of detection would be known precisely in such implementations, i.e., the particular sensor that detected the mobile station 12 identifies the location of the mobile station 12 within the event venue. In such embodiments, then, the precise location of the mobile station 12 is known from the detection event.

Moreover, such an embodiment may be used to negotiate or otherwise identify the desired feed types based on short-range signaling between the short-range wireless transceivers 36 and the mobile station 12. Further, depending upon the desired types of event feeds and on the supported data rates, the communication links between the wireless transceivers 36 and the mobile station 12 may be used to deliver at least one of the one or more event feeds being delivered to the mobile station 12. Indeed, the mobile station 12 may be provided one or more event feeds through the local wireless communication network 34, while still being provided with one or more additional event feeds via the typically lower-rate communication link with a wireless transceiver 36. Of course, if the data rates are sufficient, the local communication network 34 may not be needed, and event feed service could be provided by a mesh or network of the wireless transceivers 36.

Thus, it is contemplated herein that, in one or more embodiments, event venue seating incorporate short-range wireless transceivers, whether based on Bluetooth or other short-range wireless communication standards. Those wireless transceivers can be used to detect the presence of the mobile station 12, to advertise event feed services, to register or otherwise negotiate for the desired types of event feeds, and to deliver one or more of those event feeds to the mobile station.

As a further detail, the system 10 may include or be associated with one or more event gathering systems 38. These systems may include raw camera feeds, processed camera feeds, statistic servers (or communication links therewith), etc. Indeed, the event gathering systems 38 may include communication links to third-party servers/databases, which contain information relevant to the live event ongoing at the event venue 30, as well as local systems and devices generating real-time or near real-time electronic content related to the live event. Again, non-limiting examples include camera and microphone feeds within the event venue, replay systems, etc.

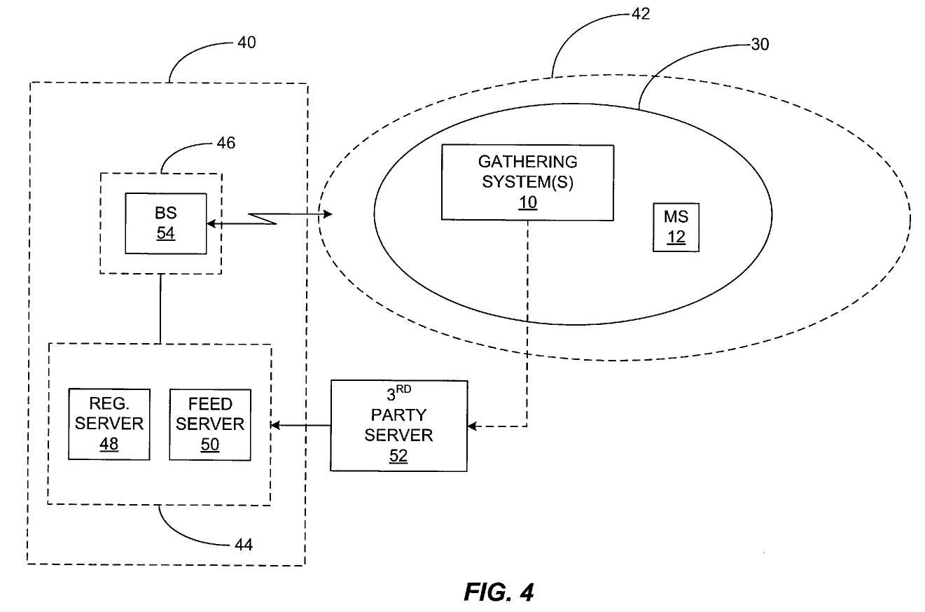

FIG. 4 illustrates another embodiment, wherein the system 10 (not enumerated in the figure) is implemented at least partially in a cellular communication network 40, which provides radio coverage in a geographic service area 42 that encompasses the event venue 30. The illustrated network architecture is subject to change as a function of the particular network type (e.g., GSM/EDGE, WCDMA/LTE, etc.). Thus, as a non-limiting example, the illustrated cellular communication network 40 includes a core network 44 and a radio access network 46. The core network 44 includes a registration server 48, or other access/authorization/accounting entity, which may be configured with subscriber information for the mobile station 12. The subscriber information can identify default selections for the desired types of event feeds and/or can identify subscription information that pertains to pre-selected types or levels of event feeds.

The illustrated core network 44 further includes a feed server 50, which may be a separate node within the core network 50, or which may be integrated or co-located with another network entity. In any case, the feed server 50 may include all or part of the detection system 10 illustrated in FIG. 1. In at least one embodiment, the feed server 50 includes one or more of the detection processor 14, the service configuration processor 16, and the content processor 18, as illustrated in FIG. 1.

In one or more embodiments, the feed server 50 is directly or indirectly linked to a third-party server 52, which provides the electronic content for the various types of event feeds, i.e., the third-party server 52 provides the source data for creating the event feeds. Indeed, the third-party server 52 may be part of local equipment implemented at the event venue 30, or at least associated therewith. The third-party server 52 may communicate directly with the feed server 50 in the core network 44, or it may link to the feed server 50 through an interworking function, which may be part of the feed server 50, or which may be separately implemented.

Regardless, in the illustrated embodiment, the base station 54 comprises or otherwise includes one or more communication circuits, e.g., radiofrequency transceivers and the associated signal/call processing circuitry. The feed server 50 thus sends the desired types of event feeds to the mobile station 12 via the base station communication circuits. Further, the base station 54 provides a mechanism for the mobile station 12 to communicate with the feed server 50, such as for determining that the mobile station 12 is physically present at the event venue 30 and/or for negotiating or otherwise identifying the types of event feeds desired by the mobile station's subscriber.

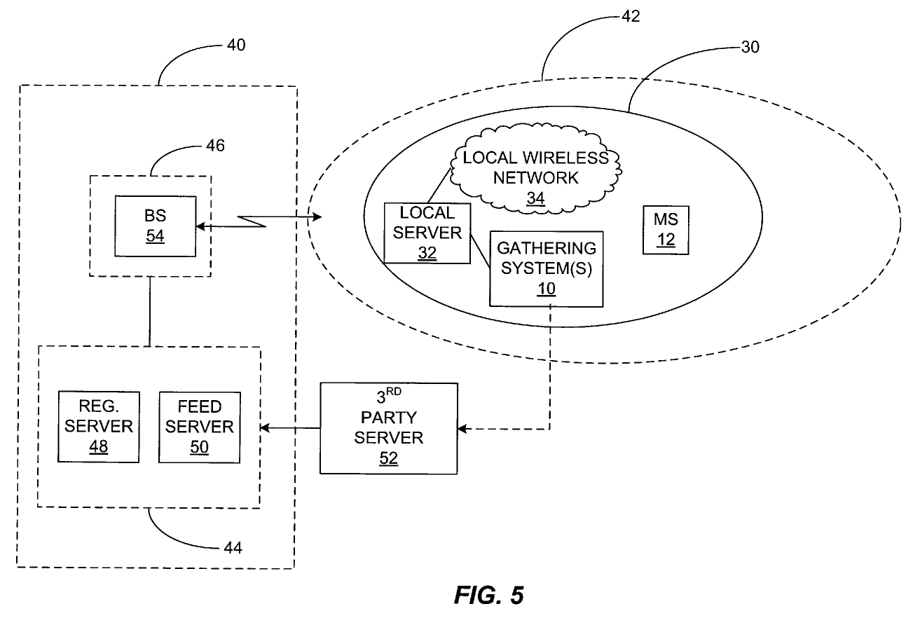

FIG. 5 illustrates another contemplated variation, wherein delivering event feeds to the mobile station 12 uses one or both the cellular communication network 40 and the local wireless communication network 34 implemented at the event venue 30. For example, the local wireless communication network 34 may be used to detect the presence of the mobile station 12, and, in at least some cases, to interact with the mobile station 12 to determine the desired types of event feeds. (Even in such cases, however, there may be communications back to entities within the cellular communication network 40, such as for authorization and billing information.)

Even where the local wireless communication network 34 is used for presence detection and/or event feed service negotiation, the actual event feeds may be delivered to the mobile station 12 via the cellular communication network 40. Of course, one or more of the event feeds desired for delivery to the mobile station 12 may be better delivered via the local wireless communication network 34, which may, for example, offer higher data rates or higher QoS, or which may be lower cost. As one example, the data rates available via a local WiFi network implementation within the event venue 30 may be better than that of the cellular communication network 40.

Of course, the cellular communication network 40 still can be used for determining that the mobile station 12 is physically present at the event venue 30. As an example of this, the mobile station 12 may include GPS circuitry and, as such, may provide the cellular communication network 40 with location information. The detection processor 14 of FIG. 1 can, for example, use GPS information, signal time-of-arrival information, or explicitly reported presence information, to determine that the mobile station is at the event venue 30. The cellular communication network 40 also can be used for authorization and accounting services associated with delivering the event feeds to the mobile station 12. Also, as mentioned earlier, the cellular communication network 40 may store or otherwise access subscriber information for the mobile station 12 that identifies desired event feed types based on preconfigured subscription information, or at least identifies capabilities of the mobile station 12, which may be used to identify the appropriate types of event feeds.

In general, it is contemplated that, regardless of how the mobile station 12 is detected and regardless of how the mobile station 12 is registered for the desired types of event feeds, there may be two or more bearer services available for delivering event feeds to the mobile station 12. In this regard, then, one bearer service in particular may be “better” for delivering one or more of the desired types of event feeds.

As such, the system 10 described herein may include bearer selection processing, wherein it selects the best bearer for one or more of the event feeds requested for the mobile station 12. For example, the service configuration processor 16 may be configured to perform bearer selection, at least for one of the one or more desired types of event feeds. Such selection may be based on QoS and/or data rate considerations, network congestion or availability considerations, and/or economic considerations, such as air time costs. Of course, bearer selection processing may attempt to optimize multiple considerations, such as optimizing a set of considerations, including QoS, cost, and congestion.

Therefore, those skilled in the art will appreciate the opportunities for using one or more network types in a complementary fashion, and will appreciate that the particular implementation may vary, depending upon implementation preferences. Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A method of delivering location-based event content to a mobile station comprising:
determining that the mobile station is physically present at an event venue;
identifying desired types of event feeds for the mobile station for a live event at the event venue; and
dynamically delivering one or more event feeds of the desired types to the mobile station.

2. The method of claim 1, wherein determining that the mobile station is physically present at the event venue comprises receiving an indication that a local detector at the event venue has detected the physical presence of the mobile station.

3. The method of claim 1, wherein determining that the mobile station is physically present at the event venue comprises receiving Global Positioning System (GPS) based location information for the mobile station, wherein the GPS based location information indicates that the mobile station is physically present at the event venue.

4. The method of claim 1, wherein identifying desired types of event feeds for the mobile station for a live event at the event venue includes communicating with the mobile station via a local wireless link available at the event venue to obtain information for identifying the desired types of event feeds.

5. The method of claim 4, further comprising implementing the local wireless link as a plurality of local wireless links implemented at individual seating or viewing areas of the event venue.

6. The method of claim 5, further comprising using individual ones of the plurality of individual wireless links to perform at least one of said detecting that the mobile station is physically present at the event venue and said dynamically delivering the one or more event feeds of the desired types to the mobile station.

7. The method of claim 1, wherein identifying desired types of event feeds for the mobile station for a live event at the event venue comprises determining the desired types of event feeds based at least in part on preconfigured subscriber information associated with the mobile station.

8. The method of claim 1, wherein identifying desired types of event feeds for the mobile station for a live event at the event venue comprises determining the desired types of event feeds based at least in part on receiving information from the mobile station identifying the desired types of event feeds.

9. The method of claim 1, wherein identifying desired types of event feeds for the mobile station for a live event at the event venue comprises communicating with the mobile station responsive to detecting the presence of the mobile station at the event venue, to advertise available types of event feeds to a user of the mobile station and to receive event feed selection information from the user of the mobile station.

10. The method of claim 1, further comprising tailoring at least one of the one or more event feeds delivered to the mobile station based on an event viewing perspective within the event venue that is associated with the mobile station.

11. The method of claim 1, wherein dynamically delivering one or more event feeds of the desired types to the mobile station includes determining a preferred bearer service for at least one of the one or more event feeds and delivering the at least one event feed to the mobile station via the preferred bearer service.

12. The method of claim 11, wherein available bearer services comprise a cellular communication network bearer service and a local network bearer service and wherein determining the preferred bearer service for the one or more event feeds comprises determining which one of the available bearer services is better for the at least one feed with respect to at least one of cost and performance.

13. The method of claim 1, wherein detecting a presence of the mobile station at a defined seating or viewing location within the event venue comprises detecting the presence of the mobile station via a short-range wireless transceiver at the event venue, and further comprising at least one of identifying desired types of event feeds based on communicating with the mobile station via the short-range wireless transceiver, and dynamically delivering at least one of the one or more event feeds of the desired types to the mobile station via the short-range wireless transceiver.

14. The method of claim 1, wherein dynamically delivering one or more event feeds of the desired types to the mobile station comprises delivering at least one of the one or more event feeds to the mobile station via a supporting wireless communication network.

15. The method of claim 14, wherein the supporting wireless communication network includes at least one of a cellular communication network associated with the mobile station and a local wireless communication network associated with the event venue.

16. The method of claim 15, further comprising linking one or more feed servers providing content for event feeds to the supporting wireless communication network, such that the supporting wireless communication network delivers event feed content from the one or more feed servers to the mobile station.

17. A system for delivering location-based event content to a mobile station comprising:
a detection processor configured to determine that the mobile station is physically present at an event venue;
a service configuration processor configured to identify desired types of event feeds for the mobile station for a live event at the event venue; and
a content processor configured to dynamically deliver one or more event feeds of the desired types to the mobile station.

18. The system of claim 17, wherein the detection processor, the service configuration processor, and the content processor comprise a feed server associated with a cellular communication network.

19. The system of claim 17, wherein the content processor is operatively associated with one or more communication circuits that are configured to deliver the one or more event feeds to the mobile station.

20. The system of claim 17, wherein the detection processor, the service configuration processor, and the content processor comprise one or more nodes in a wireless communication network that comprises at least one of a cellular communication network providing service coverage for a geographic area that includes the event venue and a local wireless communication network implemented at the event venue.

21. The system of claim 20, wherein the content processor is operatively associated with one or more base stations in the cellular communication network for delivering at least one of the one or more event feeds to the mobile station via wireless signaling from the one or more base stations.

22. The system of claim 17, wherein the system includes a local wireless communication network implemented at the event venue, wherein the local wireless communication network includes or is associated with the detection processor and provides for wireless detection of the physical presence of the mobile station at the event venue.

23. The system of claim 17, wherein the content processor is operatively associated with at least two wireless bearer services for delivering event feeds, and wherein the system is configured to select a preferred one of the at least two wireless bearer services for delivering at least one of the one or more event feeds that are dynamically delivered to the mobile station.

24. The system of claim 23, wherein the system is configured to determined the preferred one of the at least two wireless bearer services based on preconfigured selection preferences or based on dynamic evaluation of performance requirements and cost associated with delivering the at least one event feed to the mobile station.
